(19) United States
(12) Patent Application Publication
(10) Pub. No.: US 2002/0149812 A1
(43) Pub. Date: Oct. 17, 2002

(54) Method and procedures for system test and verification of optical networks using noise injection/loading

(76) Inventors: Junhua Hong, Nashua, NH (US); Jianying Zhou, Acton, MA (US)

Correspondence Address: LAHIVE & COCKFIELD, 28 STATE STREET, BOSTON, MA, 02109, US

(21) Appl. No.: 09/837,769

(22) Filed: Apr. 17, 2001

(51) Int. Cl. H04B 10/08; H04J 14/02

(52) U.S. Cl. 359/110; 359/124

(57) ABSTRACT

The present invention enables system verification and test of high quality optical networks with extremely low BER. The invention allows investigation of optical nonlinear penalty contributions by varying channel power while keeping constant OSNR at the receiver end. The present invention provides a method to measure system performance gains and penalties associated with different dispersion maps. The present invention gives simple automated test procedures which ensures fast test time. The present invention comprises a transmitter for transmitting an optical test signal to the optical network. The present invention includes a first attenuating module for attenuating channel power of the optical test signal. Also, the present invention includes a noise injection module for adding noise to the optical test signal. Further, the present invention includes a second attenuating module for adjusting the channel power of the optical test signal so that the optical test signal can be detected by a receiver, and a test module for calculating the BER based on the optical test signal received at the receiver.

### TECHNICAL FIELD OF THE INVENTION

The present invention is directed to testing and verifying operating characteristics of an optical network using noise injection/loading.

### BACKGROUND OF THE INVENTION

Bit error rate (BER) is a conventionally used parameter for evaluating the performance characteristics of an optical fiber communication system. BER is defined as the ratio between the number of erroneously received bits to the total number of received bits over a period of time. The BER calculated at a receiver encompasses all impairments suffered by the signal between the transmitter and receiver. Most optical systems have very low BER, under nominal conditions of operation.

Performance is also measured by a parameter “Q”. The Q value indicates the signal-to-noise ratio (SNR) of the electrical signal regenerated by the optical receiver. The parameter Q directly corresponds to the bit error rate (BER) performance of the optical system.

Measuring BER can be quite time consuming, especially for systems with low BER. For a traffic channel with a transmission rate of 10 Gb/s, it takes about 28 hours to measure the minimum statistic error count of 10 at a BER measure of 10⁻¹⁵.

The signal-to-noise ratio (SNR) is a metric that is used to characterize system performance SNR. Noise is generally independent of the signal level in a non-optical system. Absent distortion, SNR is the sole determinant of BER.

However, in optical systems there are some signal dependent BER penalties. Not only does the BER depend on the optical SNR (OSNR), but the BER also depends on the signal level and the level of received power.

There are also ways for measuring the performance characteristics of an optical transmission system by examining an eye closure diagram. The eye closure diagram is a diagram produced on a standard oscilloscope when a signal is used as vertical input of the oscilloscope. In each binary signal, the eye diagram may show a fully opened eye, a fully closed eye or a partially closed eye somewhere in the range between the fully opened eye and the fully closed eye. A fully opened eye is desirable and represents the ideal case. Variations in how open the eye is demonstrates instability in the signal.

After an optical network has been configured, it is generally desirable to perform system “test and verification”. The verification verifies that the optical network performs as intended and is used to properly calibrate the system. One aspect of this verification is to apply noise to the optical network to determine how much system that the optical network has. Such “noise injection/loading” helps to better characterize the system, and provide system noise margin for various system degradations and unforeseeable events. System OSNR can be changed by varying transmitter power level or provision of system Booster Amplifier gain/power. Unfortunately, non-linear distortion of the optical signal is channel power dependent and thus varies with channel power. As a result, it is difficult to appreciate what portion of the signal response is due to the noise and what portion is due to the distortion since the distortion varies non-linearly with the changing power level. Conventionally, optical noise loading is performed by directly coupling broad band ASE noise into the test system. This approach, though looks straightforward, it suffers from several drawbacks: 1. signal power loss (at least 50%) due to direct power coupling; 2. More complicate test automation procedures, more iterations are required; 3. Require high power broad-band noise source.

### SUMMARY OF THE INVENTION

The present invention provides an improved approach for performing system test and verification. The illustrative embodiment of the present invention uses a one stage amplifier operating at constant power in conjunction with two optical attenuators to incorporate noise into an optical network. The illustrative embodiment allows a DWDM optical network test time to be sharply reduced and other system performance penalties, such as, non-linear distortion contributions to be isolated from noise contributions.

According to one aspect of the present invention, an optical noise injection/loading circuit for use in system test and verification is provided. The noise injection/loading circuit includes an optical noise injection/loading amplifier for adding noise to the optical network, said noise injection/loading amplifier configured to constant output power mode. The noise injection/loading circuit is also comprised of an optical attenuator connected in series with the optical noise injection/loading amplifier for receiving the signals to be applied to the noise injection/loading amplifier and for attenuating the signal to adjust the signal to noise ratio (OSNR) of output from the noise injection/loading amplifier.

According to another aspect of the present invention, a system is provided. The system is comprised of an optical network. The system is also comprised of a transmitter for applying a test signal to the optical network for testing the optical network. The system is further comprised of a noise injection/loading circuit. The noise injection/loading circuit includes an optical noise injection/loading amplifier for applying noise to the optical network, said noise injection/loading amplifier configured in constant output power mode. The noise injection/loading circuit is also comprised of an optical attenuator connected in series with the optical noise injection/loading amplifier for receiving the signals to be applied to the noise injection/loading amplifier and for attenuating the signal to adjust the signal to noise ratio (OSNR) of output from the noise injection/loading amplifier.

According to another aspect of the present invention, in an optical network a method is provided. The method is comprised the step of transmitting an optical signal to the optical network. The method is also comprised the step of attenuating channel power of the optical test signal. The method include the step of varying channel power of the optical test signal. The method further includes estimating system performance penalties due to signal non-linear distortions.

According to another aspect of the present invention, in an optical network a method of testing the optical network is provided. The method includes the step of providing a noise injection/loading circuit in the optical network, wherein said noise injection/loading circuit includes an optical noise injection/loading amplifier for adding noise and an optical attenuator for attenuating input signal power of input to the optical noise injection/loading amplifier. The method includes the step of configuring the noise injection I loading optical amplifier in constant output power mode. The method includes the step of setting the optical attenuator to a first level of attenuation. The method includes the step of applying a first test signal to the optical network. The method includes the step of calculating a first measurement of a performance metric for the optical network. The method includes the step of setting the optical attenuator to a second level of attenuation. The method further includes the step of calculating a second measurement of a performance metric for the optical network.

### BRIEF DESCRIPTION OF THE DRAWINGS

FIG. 1 shows a schematic of a system test and verification configuration for use in an illustrative embodiment of the present invention.

FIG. 2 shows a flowchart of steps employed in the testing processing.

### DETAILED DESCRIPTION

The illustrative embodiment of the present invention provides an approach to optical noise injection/loading which facilitates the selection of channel power and OSNR without disturbing other related penalty factors. The quality and performance of an optical network with fiber plants of various types and span lengths can be investigated though system Bit Error Ratio Test (BERT). However, the interplay of so many parameters, such as, channel power, optical signal to noise ratio (OSNR), dispersion map, and fiber non-linearity, make it difficult to tell whether one network is optimized in every respect. One of the best ways to examine system performance characteristics is to isolate each penalty-contributing factor.

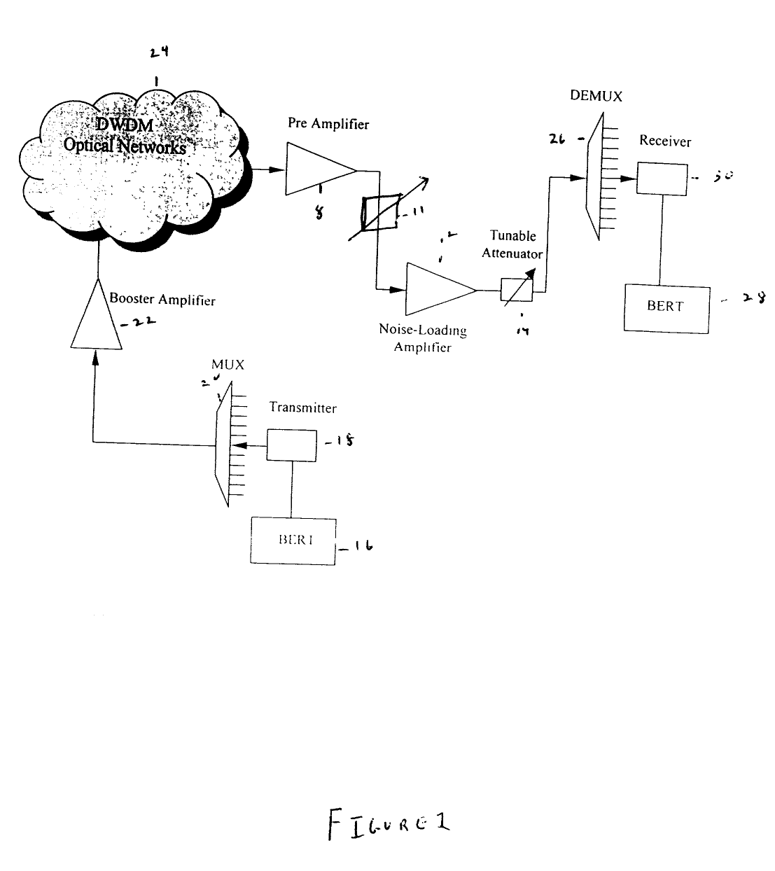

FIG. 1 depicts a schematic of a test and verification configuration for use in the illustrative embodiment of the present invention. Th e most efficient way to measure performance of an optical network is by estimating noise margin in the system and understanding major penalty contributing factors. As stated above, the illustrative embodiment controls OSNR while adjusting other system conditions. The present invention uses a noise injection/loading technique to facilitate the verification of the optical network. In order to avoid disturbing the optical network, the illustrative embodiment introduces noise injection/loading only at the final stage of the optical network. The optical network includes an optical test signal used to measure system performance.

The illustrative embodiment employs noise injection/loading so that the received test signal experience OSNR degradation. The noise injection/loading occurs without lowering the provisional power of the test signal. Also, the illustrative embodiment permits variation in the OSNR value of the test signal without changing provisional channel power. The resulting test signals may be monitored to accurately characterize system performance under varying OSNR conditions.

In general, all non-linear, such as self-phase modulation (SPM), four-wave mixing (FWM), cross phase modulation (XPM), and modulation instability (MI) and chromatic dispersion contribute to lowering the performance of an optical system and effect the value of the BER. The technique used in the present invention is based on the fact that many distortion components manifest themselves as optical phase noise and are not associated with the values of the OSNR. It is known that the BER of optical systems depends not only on the OSNR, but also on the optical signal power in the transmission media, and the level of the received power. To this end, the OSNR is lowered by adding noise over the information signal. Thus, the value of the OSNR is lowered at the output which results in equalizing the noise margin in an optical signal in the system.

The optical network environment includes a Bit Error Rate Test (BERT) module 16. The optical transmitter 18 issues express test signals (pass through all network elements along the route from the transmitter end to the receiver end) over multiple channels that are multiplexed by a multiplexer 20 into a combined signal. The combined signal is amplified by a booster amplifier 22 and transmitted to the optical network 24. The optical network 24 may be, for example, a wavelength division multiplexing (WDM) network or a dense wavelength multiplexing (DWM) network.

The combined signal then passes through a preamplifier that amplifies the combined signal. Noise is added to the combined signal by noise injection/loading amplifier 12. The noise injection/loading amplifier 12 is operated in constant output power mode. The ratio of noise to the combined signal is controlled by tunable optical attenuator 11. If a high level noise is desired, the tunable attenuator 11 performs large attenuation, whereas if low levels of noise are desired, the tunable optical attenuator 11 performs less significant attenuation. A second tunable optical attenuator may be positioned after the noise-loading amplifier 12 to adjust the power level of the output of the noise injection/loading amplifier 12 to an appropriate level for the receiver 30.

A demultiplexer receives the combined signal with the noise added and demultiplexes the combined signal into the respective channels that are received by the receiver 30. The received channels then may be processed by a BERT module 28 to calculate BER.

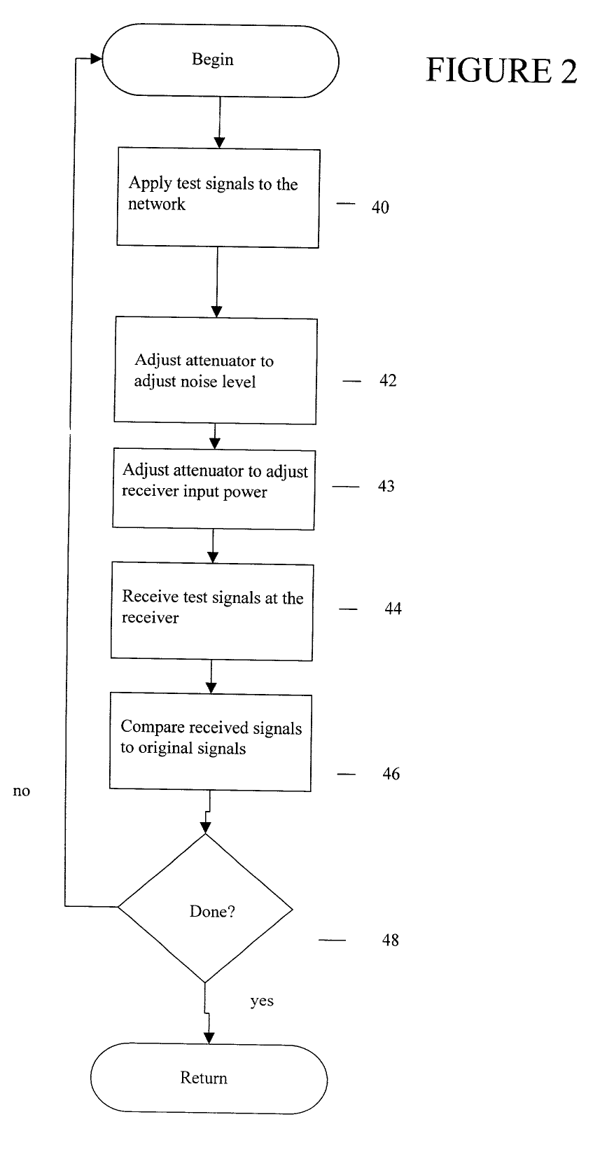

FIG. 2 shows a flowchart of the testing process that may be applied during verification of an optical network. The testing begins with the transmitter 18 applying the test signals to the optical network (step 40). The BERT 18 maintains information about the signals that are applied so that these signals can be used as references to those received at the receiver 30. The tunable optical attenuator is set to adjust the OSNR (step 42). The receiver input power is controlled by the second tunable optical attenuator. The tunable attenuator is adjusted to adjust the receiver input power (step 43). The test signals are received at the receiver 30 (step 44). The received signals are available to the BERT module 28 at the receiving end. The received signals may then be compared to determine the BER for the given noise level. (step 46)

The above described process may then be repeated (see step 48) for different OSNR levels. The OSNR level may be adjusted by setting the tunable optical attenuator 11. The BER may be calculated for each of the various OSNR levels to obtain a profile of BER with a range of OSNR levels.

It should be appreciated that the BERT modules 16 and 20 may convert the optical signals into electrical form or may process the signals in digital form. The BERT modules may be any of a number of conventionally used modules for measuring BER. Moreover, those skilled in the art will appreciate that various test patterns may be applied during the testing. The present invention is not limited to a particular test pattern or testing protocol.

While the present invention has been described with reference to an illustrative embodiment, those skilled in the art will appreciate that various changes in form and detail may be made without departing from the intended scope of the present invention as defined in the appended claims.

Having described the invention, what is claimed as new and protected by Letters Patent is

What is claimed:

1. A noise injection/loading circuit for use in noise loading an optical network, said noise injection/loading circuit comprising:
an optical noise injection/loading amplifier for applying noise to the optical network, said noise injection/loading amplifier configured to output at a fixed power level; and
an optical attenuator connected in series with the optical noise injection/loading amplifier for receiving the signals to be applied to the noise injection/loading amplifier and for attenuating the signal to adjust the signal to noise ratio of output from the noise injection/loading amplifier.

2. The circuit of claim 1 further comprising a second optical attenuator for adjusting power of the output for the noise injection/loading amplifier to an appropriate level for a receiver.

3. The circuit of claim 1 wherein the optical attenuator is tunable.

4. In an optical network, a method comprising the steps:
transmitting an optical test signal to the optical network;
attenuating channel power of the optical test signal;
adding noise to the optical test signal; and
calculating the BER based on the optical test signal received at the receiver.

5. The method of claim 4 wherein the noise is created by a one-stage noise-loading amplifier.

6. The method of claim 4 wherein the amplifier is operated at constant output power.

7. The method as recited in claim 4 the attenuating is done to establish a given optical signal noise ratio.

8. A system, comprising:
an optical network;
a transmitter for applying a test signal to the optical network for testing the optical network; and
a noise injection/loading circuit, comprising:
an optical noise injection/loading amplifier for applying noise to the optical network, said noise injection/loading amplifier configured to output at a fixed power level; and
an optical attenuator connected in series with the optical noise injection/loading amplifier for receiving the signals to be applied to the noise injection/loading amplifier and for attenuating the signal to adjust the signal to noise ratio of output from the noise injection/loading amplifier.

9. The system of claim 8 further comprising a receiver for receiving output from the noise injection/loading circuit.

10. The system of claim 9 further comprising a Bit Error Rate Tester (BERT) for measuring BER of output received at the receiver.

11. The system of claim 10 wherein the BERT has a module in communication with the transmitter and a module in communication with the receiver.

12. The system of claim 9 wherein the noise injection/loading circuit is positioned between the optical network and the receiver.

13. The system of claim 9 wherein the noise injection/loading circuit includes a second optical attenuator for adjusting output from the optical noise loading amplifier to an appropriate power level for the receiver.

14. The system of claim 8 wherein the optical attenuator is tunable.

15. In an optical network, a method of testing the optical network, comprising:
providing a noise injection/loading circuit in the optical network, wherein said noise injection/loading circuit includes an optical noise injection/loading amplifier for adding noise and an optical attenuator for attenuating input signal power of input to the optical noise injection/loading amplifier;
configuring the noise injection/loading optical amplifier to be in constant output power mode;
setting the optical attenuator to a first level of attenuation;
applying a first test signal to the optical network;
calculating a first measurement of a performance metric for the optical network;
setting the optical attenuator to a second level of attenuation; and
calculating a second measurement of a performance metric for the optical network.

16. The method of claim 15 wherein the performance metric is Bit Error Ratio (BER).

17. The method of claim 15 wherein the optical attenuator is set to the first level of attenuation to achieve a first optical signal to noise (OSNR) ratio.

18. The method of claim 15 wherein the optical attenuator is set to the second level of attenuation to achieve a second optical signal to noise ratio (OSNR).

19. The method of claim 15 further comprising the step of composing the first measurement and the second measurement of the performance metric to determine if the optical network behaves as anticipated.

20. The method of claim 19 further comprising the step of attenuating output from the optical noise injection/loading amplifier.
